(19) United States
(12) Patent Application Publication
(10) Pub. No.: US 2010/0169155 A1
(43) Pub. Date: Jul. 1, 2010

(54) Widget Development Tool

(75) Inventor: Daria A. Loi, Portland, OR (US)

Correspondence Address: TROP, PRUNER & HU, P.C., 1616 S. VOSS RD., SUITE 750, HOUSTON, TX, 77057-2631, US

(73) Assignee: Intel Corporation

(21) Appl. No.: 12/345,784

(22) Filed: Dec. 30, 2008

(51) Int. Cl. G06Q 10/00; G06F 3/048; G06Q 30/00

(52) U.S. Cl. 705/10; 715/764; 715/751; 705/12; 715/810

(57) ABSTRACT

In an interactive television system, a proposal widget may be included which enables users to submit proposed widgets. Other users may comment on the proposed widgets and the proposal widget may also be used to enable users to see the results of deliberations about the proposed widgets.

### BACKGROUND

This relates generally to interactive television.

In interactive television, television content may be linked in various ways to Internet-based content. Thus, in some cases, the Internet content may be topically related to the television content and, in other cases, the Internet content may be unrelated to the television content. Through interactive television, television viewers can access information they may be interested in on the Internet. That ability to access the Internet may be achieved through user interfaces associated with the television display.

The widget channel is a form of interactive television in which a banner is displayed across the lower portion of a television display screen. The banner may be divided into a plurality of boxes, called widgets, which may be selected by the user, for example, using a television remote control. Upon selection, a graphical user interface appears over part, but generally not all, of the television display screen, providing additional information or user selections. Thus, in some embodiments, each of the boxes at the bottom of the screen can be thought of as widgets and the pop up or overlay that displays over the display screen provides interactive content from the Internet. As used herein, a widget channel is a software stack to access content through a television system.

### BRIEF DESCRIPTION OF THE DRAWINGS

FIG. 1 is a schematic depiction of one embodiment of the present invention;

FIG. 2 is shows a typical widget display screen layout in accordance with one embodiment;

FIG. 3 is an operational depiction of one embodiment of the present invention; and

FIG. 4 is a flow chart for one embodiment of the present invention.

### DETAILED DESCRIPTION

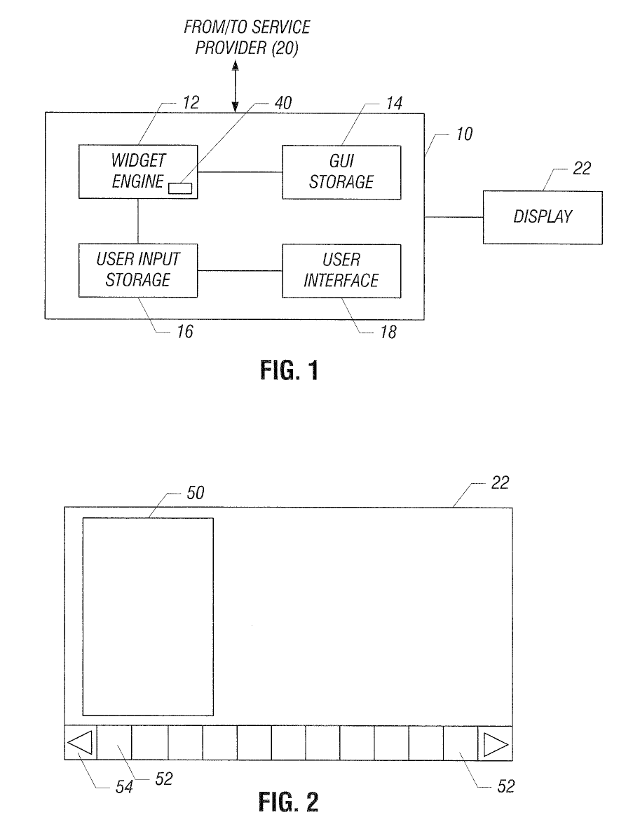

Referring to FIG. 1, a video display 22 may be connected to a controller 10 in one embodiment. The display 22 may be any video display associated with any media playing device, including a television display.

Typically, the controller 10 is coupled to a source of television programming, such as a cable or satellite service provider. Typically, the controller 10 may be a set top box, advanced DVD and media player or may simply be part of the television itself.

Thus, the controller 10 has a connection to the service provider, as indicated, and a connection to a video display 22.

The controller 10 may include a widget engine 12 which, in some embodiments, may be a general purpose processor, a special purpose processor, or a controller. In one embodiment, it may be the CE 3100 media processor available from Intel Corporation, Santa Clara, Calif. with a built-in widget channel. The widget engine 12 may be coupled to a graphical user interface storage 14, for storing the graphical user interfaces associated with widgets and a user input storage 16, which may be coupled to a user interface 18 to receive user inputs and to store them for use by the widget engine 12. In some embodiments, software 40 may be stored on the widget engine 12 or in a separate storage associated with the widget engine 12. The storage 40 may store instructions, in one embodiment, which may be executed by the widget engine 12. Thus, the storage 40 may constitute one example of a computer readable medium storing instructions that may be executed by a processor-based system.

Referring to FIG. 2, the display screen 22, in some embodiments, may display a television program displayed on the display, but may include a banner on the bottom which includes a plurality of separate display boxes 52. Other arrangements are also contemplated. Each displayed box may be considered a widget. Each widget controls a graphical user interface associated with some form of Internet content that may be selected by the user. That selection, in one embodiment, may be done by scrolling to the left or right using scroll buttons 54 in one embodiment. When the desired widget 52 is positioned all the way to the left, adjacent left scroll button 54, it may be selected using a remote control which, in some embodiments, may be a conventional television remote control.

Upon selection, a graphical user interface 50 overlays a portion, but not all, of the display screen 22. Thus, the television program continues to be visible on the display screen 22, although a portion of the display may be overlaid by the graphical user interface 50. The graphical user interface 50 may display the actual widget content. Examples of widget content may be any Internet content, either linked or associated with the television program or independent therefrom. It may include additional information about the television program, its actors, or its content. It may include other information like scores of ongoing sports events, weather, news, or other Internet information which may be accessed in the course of the television program display.

In some embodiments, viewers may participate in the selection and/or design of widgets in the widget channel. Since a large number of widgets may be provided, many different users may have a variety of different interests that may be accommodated via widgets. Moreover, the number of widget channels that may be provided by a service provider may be essentially unlimited.

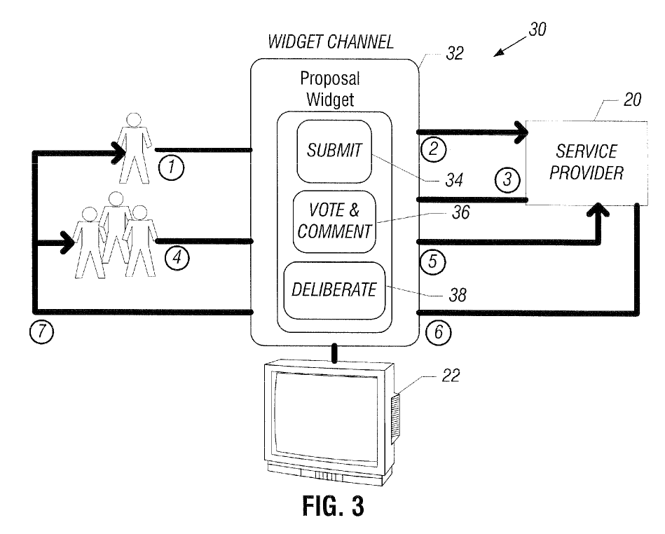

Thus, in accordance with some embodiments, a widget may control a display associated with the selection and/or design of other widgets. In other words, one of the boxes 52 in the widget channel display shown in FIG. 2 may be a widget design or selection widget called a widget proposal widget. The proposal widget graphical user interface 50 may be, in one basic form, the display 32, shown in FIG. 3. Thus, the display 32, upon selection of the proposal widget, may provide options for user selection of a submit icon 34, a vote and comment icon 36, and a deliberate icon 38.

Upon selection of the submit icon 34, the display 32 may switch to one or more user input templates that enable the user to submit information about widgets that the user wishes were available or which the user wishes to design.

Upon selection of the vote and comment icon 36, a list of widget proposals by other users, the service provider, or others is displayed. Users may vote and comment on those widget proposals. The users' feedback may be collected by the service provider 20, and the service provider may then use this information to decide which widgets to actually implement.

Finally, a user may select the deliberate icon 38 to receive information about the voting on the various widget proposals and the service provider's decision about which widget proposals may actually be made available. In some embodiments, the user may then select the widget proposals accepted for inclusion on the user's widget channel display in a box 52.

Thus, initially, the user may select the submit icon 34. Upon selection of the submit icon 34, a plurality of graphical user interfaces 50 may be provided. Each graphical user interface may be a template which may be selectable by the user to provide information about the user's widget proposal. For example, in some embodiments, relatively limited user input is provided through remote controls. Thus, the widget design templates may facilitate such input. There may be different types of templates for different types of user proposals, each template being selectable by the user so that the user may select the template that provides the greatest assistance in submitting the information about the user's proposed widget. The widget design templates may, for example, ask for information like the name of the widget channel, the number of user selectable buttons that were needed, the types of graphics that may be desired, the color scheme that the user may wish to propose, and even the advertisers that the user thinks would be most advantageous for sponsoring or advertising on the proposed widget.

As indicated at 2, in FIG. 3, after the widget proposal is entered, it is automatically transmitted to the service provider from the controller 10. The service provider then authorizes and posts the idea to proposal widget users who select the icon 36, as indicated by arrow 3. Then, as indicated by arrow 4, the proposal widget users vote and comment on the various widget proposals and these comments, entered by selecting the icon 36, are then provided back to the service provider 20, as indicated by the arrow 5. After a predetermined time has been exhausted, the service provider 20 then makes the decision about which proposals will be selected for widget channel inclusion, as indicated at 6. Authors, voters, and commentators may then be notified automatically or can access the final decision by selecting the icon 38, as indicated by the arrow 7.

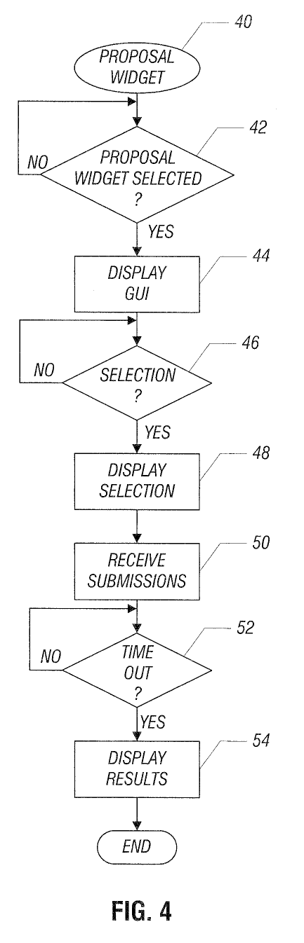

Turning next to FIG. 4, the sequence indicated in FIG. 3 may be implemented in software, hardware, or firmware. In a software implemented embodiment, the widget development software 40 may be stored on the controller 10. The widget development software 40 may begin by determining whether the proposal widget was selected, as indicated in diamond 42. In one embodiment it may be selected by selecting the box 52, associated with the proposal widget function, using a remote control. Once selected, the graphical user interface, shown in FIG. 3 at 32, may be displayed or any other graphical user interface that allows the user to make various submissions and selections, as indicated in block 44. A check at diamond 46 determines whether the user has made a selection or submitted information. If a selection is made, it is displayed in the area 50, as indicated in block 48. In addition, submissions may be received, as indicated in block 50, and those submissions are automatically provided to the service provider 20. Finally, a check at diamond 52 determines whether a time out has been reached. If so, the results may be automatically transmitted to authors, voters, and commentators and made available to those who select the deliberate icon 38, as indicated by block 54.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a widget to enable users to submit widget proposals to a service provider.

2. The method of claim 1 including providing a widget proposal widget with a plurality of other widgets on a television display screen.

3. The method of claim 2 including enabling the users to use a widget to submit a proposed widget design.

4. The method of claim 3 including enabling users to access widget proposals submitted by other users.

5. The method of claim 4 including enabling users to vote on widget proposals.

6. The method of claim 5 including accumulating widget proposals and user votes on widget proposals.

7. The method of claim 6 including receiving user inputs about an advertiser to be associated with a widget proposal.

8. The method of claim 7 including enabling a user to select an accepted widget proposal for inclusion as a widget in the user's widget channel.

9. An apparatus comprising:
a widget engine to display a proposal widget to enable a user to submit widget proposals for inclusion on a widget channel;
a connection from said widget engine to a service provider; and
a connection from said widget engine to a display.

10. The apparatus of claim 9, said widget engine to provide a plurality of templates to assist a user in submitting a widget proposal.

11. The apparatus of claim 9, said widget engine to enable users to vote on widget proposals.

12. The apparatus of claim 11, said widget engine to provide information about widget proposal approval to users.

13. The apparatus of claim 11 to allow users to select a proposed widget for inclusion in the user's widget channel.

14. The apparatus of claim 9, said widget engine to enable users to indicate an advertiser to associate with a proposed widget.

15. The apparatus of claim 9 wherein said widget engine to display the proposal widget on the same display with a plurality of other selectable widgets.
